(19) United States
(12) Patent Application Publication
(10) Pub. No.: US 2005/0069637 A1
(43) Pub. Date: Mar. 31, 2005

(54) Method for manufacturing planar optical waveguide

(76) Inventors: Byeong Soo Bae, Daejeon (KR); Ji In Jung, Daejeon (KR); Oun Ho Park, Daejeon (KR); Eun Seok Kang, Daejeon (KR)

Correspondence Address: MARTINE PENILLA & GENCARELLA, LLP, 710 LAKEWAY DRIVE, SUITE 200, SUNNYVALE, CA, 94085, US

(21) Appl. No.: 10/671,980

(22) Filed: Sep. 26, 2003

(51) Int. Cl. B05D 5/06

(52) U.S. Cl. 427/163.2

(57) ABSTRACT

A method for manufacturing a planar optical waveguide, includes the steps of coating, over a lower cladding layer, an optical waveguide layer including an inorganic-organic matrix uniformly doped with photosensitive photochemical monomers, selectively exposing the waveguide layer to a beam with a predetermined range of wavelengths so as to immobilize the doped photochemical monomers, and thermally treating the waveguide layer to remove unexposed monomers and cure the exposed optical waveguide layer. Requiring no etching processes, the method can reduce the number of processing steps and produce a planar optical waveguide with a low optical loss.

### BACKGROUND OF THE INVENTION

1. Field of the invention

The present invention relates, in general, to a method for manufacturing a planar optical waveguide and, more particularly, to a simple method for manufacturing a planar optical waveguide showing a smooth refractive index and thickness distribution between different dielectric regions, which can control the refractive index and requires no etching processes.

2. Description of the Prior Art

Optical waveguide devices are typically manufactured by use of semiconductor fabrication methods or MEMS (micro electromechanical system) techniques. Planar waveguide techniques have been developed to fabricate optical waveguide devices on planar substrates. In addition, studies have continued to be made of integrating optical waveguide devices at higher density.

In a general method, the fabrication of an optical waveguide device starts with the formation of a lower cladding layer on a substrate, followed by the deposition of a core layer over the lower cladding layer. Next, the core layer is covered with a photoresist layer which is then exposed to light and developed to make a photoresist pattern. This pattern serves to etch the core layer. Thereafter, an upper cladding layer is formed atop the patterned core layer, thereby completing optical waveguides.

Usually, the formation of the cladding layer or the core layer resorts to a spin coating or deposition process. Silica or polymeric materials with different refractive indices are used for the layers. When the cladding and the core layers are formed of silica materials, the difference of refractive index between the cladding and the core layers is 0.75% at most. In this case, the size of optical waveguide devices is so limited as to make it difficult to fabricate micro-passive components.

By contrast, polymeric materials make it possible to control the refractive index difference between core and clad layers in a broad range. In this regard, U.S. Pat. Nos. 3,809,732 and 3,953,620 describes methods for fabricating optical waveguide devices, in which a photo-locking technique is adopted to give a change in the refractive indices and thickness of polymeric materials.

However, when only the polymeric materials are introduced as materials, there appear the disadvantages of high thermal vulnerability and large chromatic dispersion and optical loss.

U.S. Pat. No. 6,054,253 discloses a process for fabricating a waveguide on a substrate, in which a photosensitive sol-gel glass material supported on a substrate is selectively exposed to radiation and etched by making use of a solubility difference between the exposed and the unexposed portions of the photosensitive sol-gel glass material. U.S. Pat. No. 6,144,795 discloses a planar optical waveguide, in which an array of waveguide cores is patterned by use of a mold.

In contrast to the present invention, the methods disclosed in these patents require complex processes for fabricating optical waveguides.

### SUMMARY OF THE INVENTION

Leading to the present invention, the intensive and thorough research on optical waveguides, conducted by the present inventors, resulted in the finding that photosensitive or photolocking properties observed upon the introduction of dopants into inorganic-organic hybrid matrixes make it possible to achieve a planar optical waveguide showing a smooth refractive index and thickness distribution between different dielectric regions, without resort to etching processes.

Therefore, it is an object of the present invention to provide a simple method for manufacturing a planar optical waveguide showing a smooth refractive index and thickness distribution between different dielectric regions, without resort to wet etching processes.

In accordance with the present invention, there is provided a method for manufacturing a planar optical waveguide, comprising the steps of coating, over a lower cladding layer, an optical waveguide layer comprising an inorganic-organic matrix uniformly doped with photosensitive photochemical monomers, selectively exposing the waveguide layer to a beam with a predetermined range of wavelengths so as to immobilize the doped photochemical monomers, and thermally treating the waveguide layer to remove unexposed monomers and cure the exposed optical waveguide layer.

### BRIEF DESCRIPTION OF THE DRAWINGS

FIG. 1 is a process diagram showing the fabrication of a planar optical waveguide in accordance with the present invention.

FIG. 2 is a microphotograph showing planar optical waveguides fabricated according to the present invention.

FIG. 3 is a three-dimensional AFM photograph showing a planar waveguide fabricated according to the present invention.

FIG. 4 is a two-dimensional AFM photograph showing a planar waveguide fabricated according to the present invention.

FIG. 5 is a microphotograph showing planar optical waveguides fabricated according to the present invention.

FIG. 6 is a near-field photograph showing a planar optical waveguide fabricated according to the present invention.

FIG. 7 shows a mask pattern of a 1×4 splitter fabricated according to the present invention.

FIG. 8 is a low magnification microphotograph of a 1×4 splitter fabricated according to the present invention.

FIG. 9 is a near-field photograph showing a 1×4 splitter fabricated according to the present invention.

### DETAILED DESCRIPTION OF THE INVENTION

The present invention is directed to a method for manufacturing a planar optical waveguide. Over a lower cladding layer is coated an optical waveguide layer comprising an inorganic-organic matrix uniformly doped with photosensitive photochemical monomers. The waveguide layer is selectively exposed to a beam with a predetermined range of wavelengths so as to immobilize the doped photochemical monomers. The waveguide layer is thermally treated to remove unexposed monomers and cure the exposed optical waveguide layer.

The term “inorganic-organic hybrid matrix” as used in the present invention means a matrix composed of inorganic and organic materials which are optical materials with transparent properties in the visible light wavelength range. Examples of the inorganic materials useful in the present invention include silica or germanium silicate, titanium silicate, and zirconium silicate. As for useful organic materials, they may be exemplified by polymethylmethacrylate and polyimide. It should be noted that above-exemplified compounds are illustrative, but do not limit the scope of the present invention.

Preferably, the inorganic-organic hybrid matrix comprises an inorganic-organic hybrid material containing silicon and oxygen atoms, with at least a fraction of the silicon being directly bonded to substituted or unsubstituted hydrocarbon atoms.

Further, the inorganic-organic hybrid matrix may comprise an oxide of the metal selected from the metal elements of groups 3A, 4A, 3B-5B of the Periodic Table, and combinations thereof. In practice, when silica is used as an inorganic material, a fraction of the silicon may be substituted with the metal selected therefrom. Examples of the substituting metal include titanium, zirconium, aluminum and germanium.

Moreover, the inorganic-organic hybrid matrix may further comprise fluorine.

Depending on required properties, different initial concentrations may be given to the hybrid material of liquid state for the inorganic-organic hybrid matrix. Generally, as the hybrid material has a larger concentration or as the compound is a larger molecular weight (that is, the solution is more viscous), the final coating is thicker.

The liquid solution of the inorganic-organic hybrid matrix is uniformly doped with a photosensitive photochemical monomer having a predetermined refractive index. When being radiated with a beam of suitable wavelengths, the monomer undergoes one or more molecular transformations.

In order to increase the number of the molecules participating in the photochemical reaction, preferably, (a) at least one monomer selected from the monomers capable of forming dimmers in the matrix upon radiation, (b) a monomer capable of chemically bonding, in the matrix, to the chains constituting the matrix upon radiation, or (c) at least one monomer capable of forming polymers in the matrix upon radiation may be introduced.

Such molecular transformations caused by radiation result in a substantial reduction of the mobility and volatility of the dopant. In this manner, dopants of high refractive index can be photochemically immobilized onto the hybrid matrix.

The refractive index of the photosensitive monomer is preferably higher than that of a liquid state of the matrix. As a rule, monomers containing polycyclic aromatic hydrocarbon nuclei or heavy atoms of high polarization show high refractive indices. The presence of these groups in the molecular structure of the dopant monomers increases the molecular weight, resulting in a reduction of the volatility. As described above, higher densities of the dopants or higher concentrations of the matrix of liquid state render the refractive index and thickness larger. Generally, the dopants are used in the range of 10 to 50% by weight.

The photosensitive monomers satisfying the above-stated conditions may be selected from the group consisting of ethyl 2-(1-naphthyl)acrylate, coumarin, acenaphthylene, naphthylmethacrylate, naphthylenethiol, benzoinethers, benzylketals, alpha-dialkoxyacetophenones, alpha-hydroxyalkylphenones, alpha-aminoalkylphenones, acyl-phosphine oxides, benzophenone/amines, thioxane/amines, and mixtures thereof.

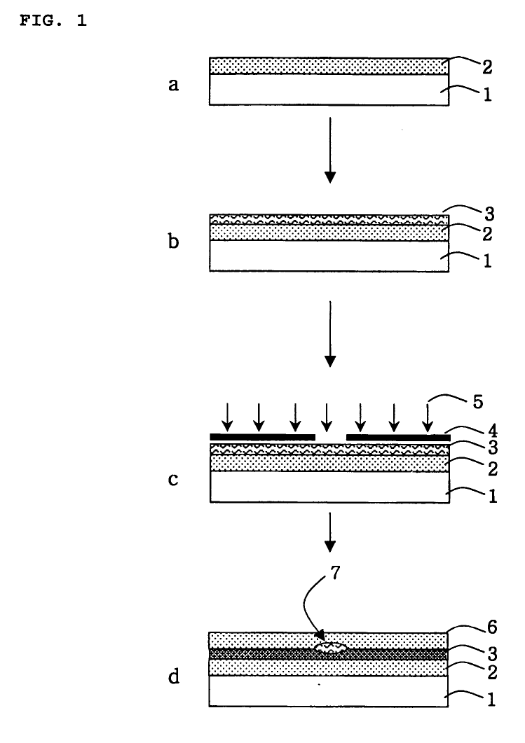

With reference to FIG. 1, there are shown processes for fabricating a planar optical waveguide using a transparent inorganic-organic hybrid matrix doped with photosensitive monomers.

First, on a substrate 1 is coated a lower cladding layer 2 which is then coated with an optical waveguide layer 3 by use of a doped inorganic-organic hybrid matrix solution. The formation of the lower cladding layer 2 and the optical waveguide layer 3 may resort to a typical method. For example, a spin coating process which is able to form a film with a uniform thickness may be applied. Prior to coating the solution, the surface to be coated must be cleaned cautiously. This cleaning process is useful for removing dust or other external materials which may affect the quality of the film coated.

Afterwards, a mask is applied onto the optical waveguide layer 3, followed by the exposure of the optical waveguide layer 3 to radiation in a specific wavelength band. This patterning process may be conducted with laser in the absence of a mask.

In the radiation process, a desired optical waveguide pattern can be made with the use of a beam in the wavelength band to which the dopant monomers are reactive. Usually, a wavelength band corresponding to UV light is utilized. A bent shape of optical waveguides can be achieved according to the specific morphology of waveguides.

To be used in the photolocking as described above, dopants which can be involved in the crosslinking of the inorganic-organic hybrid matrix so as to participate in the immobilization reaction are adopted, instead of simple photosensitive dopants. The molecular structural change of dopants occurs only in the film portion exposed to radiation. The bonding of dopant monomers to the inorganic-organic hybrid matrix in the film or the transition corresponding to the dimerization or polymerization of monomers results in a substantial or complete reduction of the mobility and volatility of the dopants in the inorganic-organic hybrid matrix.

A detailed description will be given of the molecular structural change of the dopants, with reference to examples, below.

First, because of being much larger than corresponding monomers, dimerized molecules will be entangled with each other in the long, smooth molecular chains of the inorganic-organic hybrid matrix. Ethyl 2-(1-naphthyl)acrylate, a photosensitive ester capable of forming dimers by radiation, undergoes a photochemical reaction as follows. 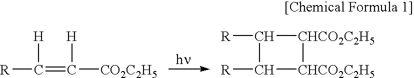
wherein R is a naphthyl group (C₁₀H₇)

Coumarin can be dimerized in the presence of a photosensitizer such as benzyldimethylketal (BDK) in the following manner.

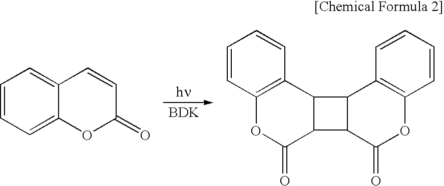

A coumarin monomer has a melting point of 64° C. while a dimer of coumarin is melted at 176.5° C. Thus, coumarin dimers remain intact even after a thermal treatment corresponding to development, giving rise to an increase in the thickness and refractive index.

Second, monomers chemically bond to the chains constituting the inorganic-organic hybrid matrix at various locations. There are two completely different reactions through which the photolocking effect utilizing the bonding of dopants to organic chains can be obtained. In one reaction, carbonyl compounds of high refractive index such as benzophenone are used as photosensitive dopants. Upon radiation, carbonyl compounds take hydrogen atoms from inorganic-organic hybrid material chains in liquids and are bonded to the chains in the following manner.

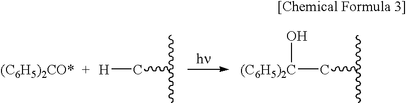

Even upon radiation, carbonyl compounds do not form dimers, nor undergo self-reaction. In the other reaction, carbonyl compounds react with carbon-carbon double bonds present within the chain of the inorganic-organic hybrid matrix. In either case, the compounds are immobilized onto the inorganic-organic hybrid matrix through practical chemical bonds.

Serial BDK reactions are shown in the following chemical formula 4. As seen in reaction (1), radiation creates two radicals. These radicals bond to organic networks as illustrated in reactions (2) and (3). In reaction (4), the benzoyl radicals produced react with each other to form a dimmer. As a result of the two reactions, the thickness and refractive index of the matrix are increased.

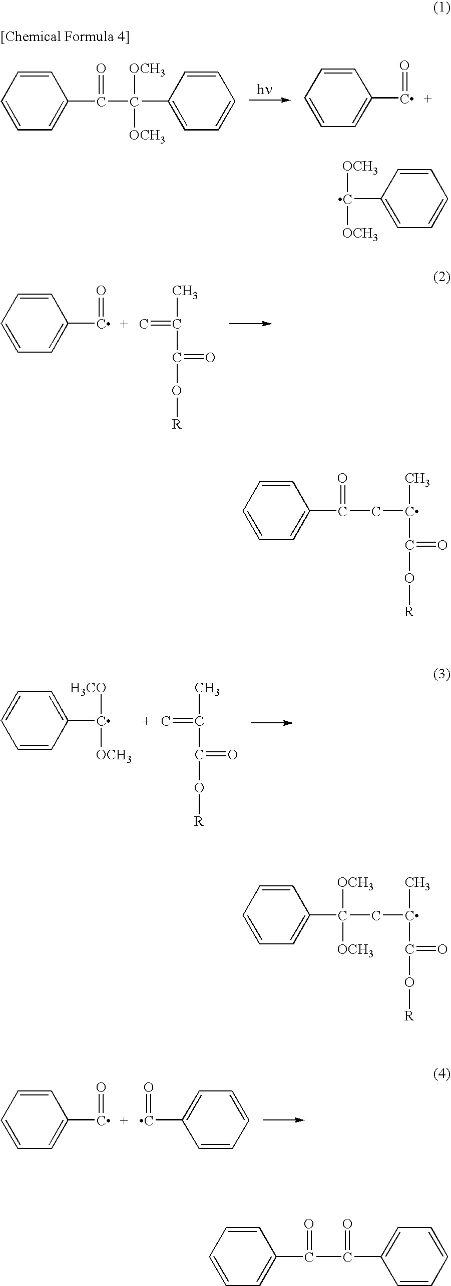

Hydroxymethylphenylpropanone (DAROCUR1173), usually used as a photoinitiator, can be divided into two radicals upon radiation, as seen in the following chemical formula 5. The benzoyl radical thus produced is bonded to the organic network as described in the BDK case.

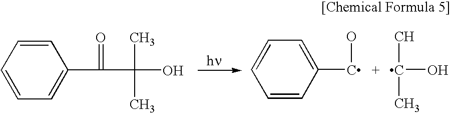

Additionally, the Diels-Alder reaction is adopted to elucidate the immobilization theory of the photolocking. In this regard, acenaphthylene serves as a high refective index photosensitive dopant. The immobilization of dopants is shown in the following chemical formula 6.

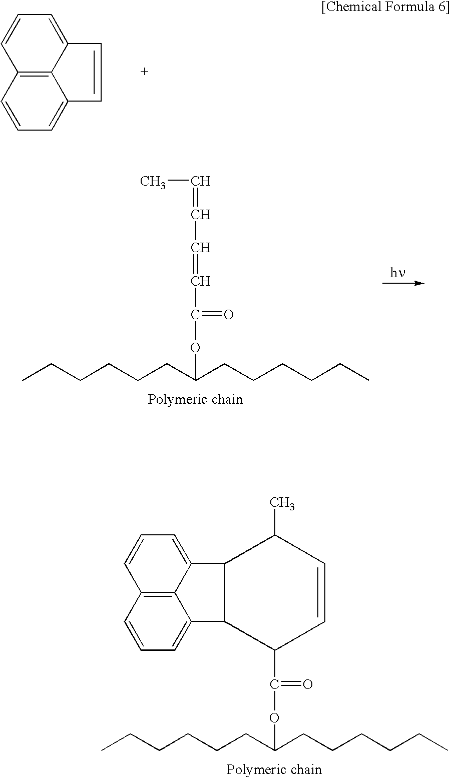

Third, when monomers are polymerized, the monomer molecules are formed into randomly arranged chains which can be easily entangled with the molecular chains of the long, smooth inorganic-organic hybrid matrix. To elucidate the polymerization of monomers in the photolocking process, the liquid solution preferably comprises polymethylmethacrylate. To the solution, naphthylmethacrylate is added as a unit chain of high refractive index. Serving as a photosensitizer, benzoinmethylether is doped in the solution. The addition of the photosensitizer makes it possible to polymerize the naphthylmethacrylate monomers by radiation.

In the radiation process, the number of the monomer molecules immobilized onto the inorganic-organic hybrid matrix increases with the intensity of the incident beam. Accordingly, as the intensity of the incident beam is larger, the change in refractive index and the final thickness become larger in radiated regions.

In the film, the cross-sectional diameter and the orientation of the beam axis can be controlled by chaning the convergence of the beam or the angle of the incident beam. Thus, when larger line widths are needed, beams with larger wavelengths are desirable. The angle or convergence of the incident beams can be reduced when the diameter of the beam increased in the film.

The wavelength of the exposure beam must be selected to show no effect to the inorganic-organic hybrid matrix itself in the film, but to initiate desired molecular transition in the monomer. Therefore, the specific wavelength selected is dependent on the monomer serving as a starting material as well as on the material of the inorganic-organic hybrid matrix. Additionally, there must be excluded the wavelengths which decompose the components of the film or adversely affect the quality of the finally produced devices.

A photolocking method may comprise the step of illuminating a light beam through a mask comprising a desired optical waveguide pattern onto a film, said light beam having a wavelength region which is of high transmissivity. This mask-utilizing technique is widely known and applied for the fabrication of semiconductor devices by use of photoresist. Furthermore, where laser is used, it can be directly radiated onto the film without a mask.

For the radiation, electrons, ions and neutrons as well as simple light sources can be employed. With respect to some starting materials, the illumination of particles may be useful in obtaining large spatial resolutions.

The subsequent step is directed to the development of the optical waveguide pattern exposed to radiation in the film. The development can be conducted simply by heating the film in order to volatize the dopants on the unexposed portions. Leaving dopants in the exposed portion of the film, the development step brings about the following results. That is, the thickness of the film is reduced in the unexposed regions due to the removal of the dopants unexposed to radiation.

A maximal temperature for the development is limited by the used dopants and the various physical and chemical properties of the inorganic-organic hybrid matrix. Account must be taken of the glass transition temperature of the inorganic-organic hybrid matrix material, the temperature-derived diffusion of the dopants immobilized onto the inorganic-organic hybrid matrix, and the thermally derived, undesirable chemical changes of materials. The development must be carried out at a temperature which has no influence on the desirable properties of the finally obtained device. For these reasons, the monomer preferably has suitable volatility such that the development is effected at relatively appropriate temperatures.

Turning to FIG. 1, finally, an upper cladding layer 6 is coated to complete the fabrication of optical waveguides 7.

As shown in FIG. 1d, the photolocking is advantageous in that optical waveguides showing a smooth refractive index and thickness distribution between different dielectric regions in a device can be manufactured. There is obtained a change of the refractive index and thickness, which is smooth and symmetrically transverse on the basis of the axis direction, corresponding to a change in the sectional area of the intensity of the exposure beam. The concentration of the immobilized, high refractive index dopants is generally the highest along the axis of radiation and decreases with the distance from the axis. The post-development thickness of the film is proportional to the concentration of the immobilized dopants. By virtue of these features, the optical waveguides are almost free from the marginal toughness causing high scattering losses, which is found in conventional waveguides.

The spatial resolution must be better than at least five micrometers. In the present invention, the ultimate resolution of the photolocking depends on the diffusion of dopants in the inorganic-organic hybrid matrix during the development, the molecular structure and size of dopants, and the material features of the inorganic-organic hybrid matrix. Researches are being made into various factors which have an effect on the resolution, and their accurate influences.

The optical waveguides manufactured by use of photolocking according to the present invention were observed to be stable over a period longer than one month at room temperature, and none of the immobilized dopants were diffused.

Although dopants of high refractive indices are described to increase the refractive index of a selected region, it is evident to those skilled in the art that dopants of low refractive indices can be photolocked in a high refractive index matrix. The use of a dopant and a matrix, which show the same refractive index, suffices for obtaining only a thickness distribution. The method described above is very useful in manufacturing optical devices having regular changes in films.

A better understanding of the present invention may be obtained in light of the following examples which are set forth to illustrate, but are not to be construed to limit the present invention.

### EXAMPLE 1

0.01 N hydrochloric acid was combined in a molar ratio of 1:1 with methyltriethoxysilane (MTES), and the resulting solution was stirred for one hour at room temperature. To this solution, phenyltrimethoxysilane (PhTMS) was added in a molar ratio of 1:1 with MTES, followed by stirring the solution for 20 min. 0.01 N hydrochloric acid was again added in the amount identical to that added above, and the resulting solution was stirred for 20 hours. Each of the monomers listed in Table 1 was added in the amount corresponding to the molar ratio of the total alkoxide to the solution which was then stirred to completely dissolve the monomer. After each of the resulting solutions was coated on a silicon wafer by use of a spin coater, the coating was exposed to a beam from a halogen-xenon lamp and dried at 150° C. for five hours. Separately, a coating made of the same solution was dried at 150° C. for five hours without being exposed. Refractive indices and thicknesses of the exposed and unexposed coatings were measured with the aid of a prism coupler. Both of the coating of the undoped solution and the unexposed coating of the doped solution were found to be 1.490 at 1550 nm as measured by the prism coupler. In Table 1, % refractive index increases and % thickness increases of the exposed coatings with respect to the unexposed coatings were summarized.

TABLE 1
< [symbol] 1>

| | | Refractive | |
|---|---|---|---|
| | | Index | Thickness |
| Dopants | Amount(%) | Increase(%) | Increase(%) |
| Ethyl 2-(1-naphthyl)acrylate | 25 | 1.1 | 18 |
| Coumarin | 15 | 0.9 | 29 |
| BDK(photosensitizer) | 5 | | |
| Benzophenone | 20 | 1.2 | 23 |
| BDK | 20 | 0.7 | 10 |
| DAROCUR1173 | 30 | 0.4 | 6 |
| Naphthalenethiol | 15 | 1.3 | 10 |
| Naphthylmethacrylate | 27 | 1 | 26 |
| Benzoinmethylether | 3 | | |
| (photosensitizer) | | | |

### EXAMPLE 2

The same procedure as that of Example 1 was carried out with the exception that methacryloxypropyltrimethoxysilane (MPTS) with a refractive index of 1.47 at 1550 nm was mixed in a molar ratio of 1:1.5 with 0.01N hydrochloric acid, this mixture was added to the solutions and stirring was conduced in the dopant-added solutions for 24 hours. The results are given in Table 2, below.

TABLE 2

| | | Refractive | |
|---|---|---|---|
| | | Index | Thickness |
| Dopants | Amount(%) | Increase(%) | Increase(%) |
| Ethyl 2-(1-naphthyl)acrylate | 25 | 1.2 | 23 |
| Coumarin | 15 | 0.9 | 31 |
| BDK(photosensitizer) | 5 | | |
| Benzophenone | 20 | 1.4 | 26 |
| BDK | 30 | 1.8 | 47 |
| DAROCUR1173 | 30 | 0.6 | 12 |
| Acenaphthalene | 20 | 1.7 | 35 |
| Naphthalenethiol | 15 | 1.4 | 12 |
| Naphthylmethacrylate | 27 | 1.4 | 34 |
| Benzoinmethylether | 3 | | |
| (photosensitizer) | | | |

### EXAMPLE 3

0.01 N hydrochloric acid was mixed in a molar ratio of 1:1 with methacryloxypropyltrimethoxysilane (MPTS) and the mixture was stirred at room temperature for one hour. Separately, zirconium propoxide (ZPO) chelated in a molar ratio of 1:1 with methacrylic acid (MAA) was stirred at room temperature for one hour. The mixture was combined in a molar ratio of 4:1 with the chelated solution, and the resulting solution was stirred for one hour, followed by the addition of distilled water to the extent that the total amount of the distilled water and the hydrochloric acid was in a molar ratio of 1:1.5 with the total alkoxide. Stirring was conduced for an additional 20 hours. The remaining procedure was carried out in the manner identical to that of Example 1, with the exception that the inorganic-organic hybrid solution was used. Coatings of the inorganic-organic hybrid solution were measured to show a refractive index of 1.50 at 1550 nm. The results are given in Table 3, below.

TABLE 3

| | | Refractive | |
|---|---|---|---|
| | | Index | Thickness |
| Dopants | Amount(%) | Increase(%) | Increase(%) |
| Ethyl 2-(1-naphthyl)acrylate | 25 | 1.3 | 25 |
| Coumarin | 15 | 1 | 35 |
| BDK(photosensitizer) | 5 | | |
| Benzophenone | 20 | 1.7 | 32 |
| BDK | 30 | 1.9 | 52 |
| DAROCUR1173 | 30 | 0.8 | 17 |
| Acenaphthalene | 20 | 1.8 | 38 |
| Naphthalenethiol | 15 | 1.4 | 13 |
| Naphthylmethacrylate | 27 | 1.5 | 40 |
| Benzoimnethylether | 3 | | |
| (photosensitizer) | | | |

### EXAMPLE 4

The same procedure as that of Example 3 was carried out, with the exception that perfluoroaklylsilane was substituted for 25 mol % of the methacrylic oxypropyltrimethoxysilane (MPTS) used. Coatings of the inorganic-organic hybrid matrix solution was found to have a refractive index of 1.454 at 1550 nm. The results are given in Table 4, below.

TABLE 4

| | | Refractive | |
|---|---|---|---|
| | | Index | Thickness |
| Dopants | Amount(%) | Increase(%) | Increase(%) |
| Ethyl 2-(1-naphthyl)acrylate | 25 | 1.4 | 20 |
| Coumarin | 15 | 0.1 | 32 |
| BDK(photosensitizer) | 5 | | |
| Benzophenone | 20 | 1.8 | 33 |
| BDK | 20 | 1.4 | 25 |
| DAROCUR1173 | 30 | 0.7 | 12 |
| Acenaphthalene | 20 | 1.6 | 35 |
| Naphthalenethiol | 15 | 1.5 | 12 |
| Naphthylmethacrylate | 27 | 1.5 | 38 |
| Benzoinmethylether | 3 | | |
| (photosensitizer) | | | |

### EXAMPLE 5

The same procedure as that of Example 3 was carried out, with the exception that BDK was added in the molar ratios listed in Table 5. The results are given in Table 5, below.

TABLE 5

| | Refractive Index | Thickness |
|---|---|---|
| BDK Amount(%) | Increase(%) | Increase(%) |
| 0 | 0.1 | 3 |
| 10 | 0.7 | 34 |
| 20 | 1.4 | 47 |
| 30 | 1.9 | 52 |
| 40 | 2.5 | 58 |
| 50 | 2.8 | 62 |

### EXAMPLE 6

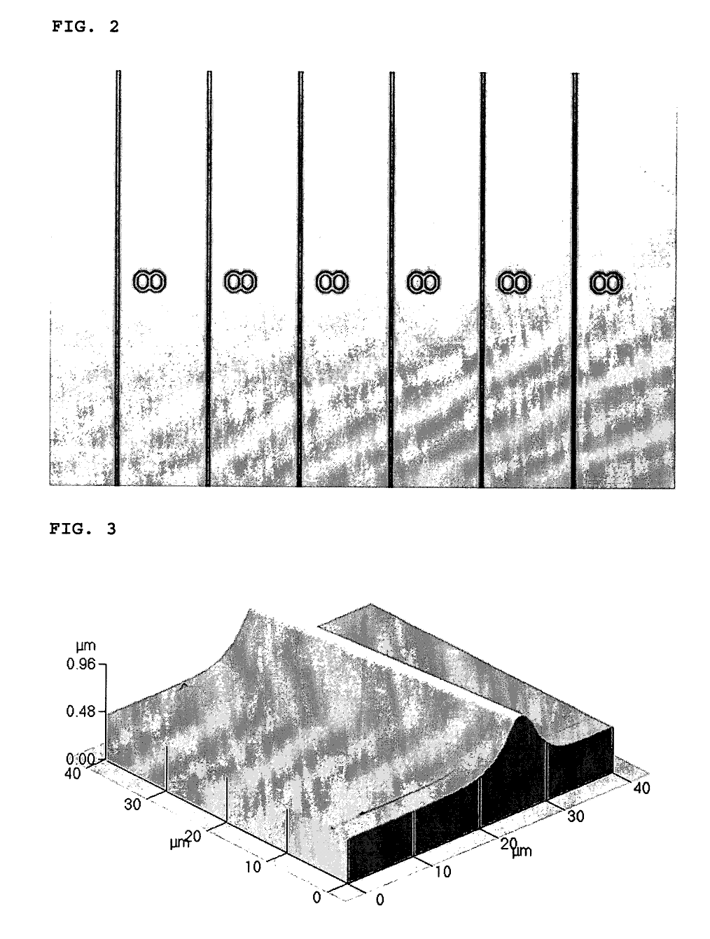

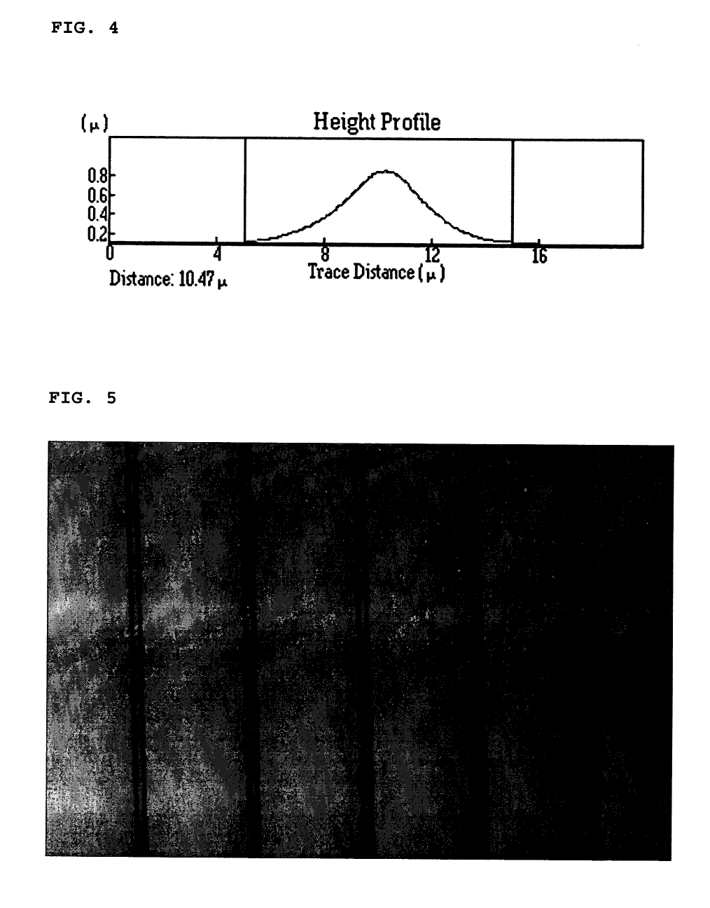

The solution containing BDK in the amount of 30 mol %, prepared in Example 5, was coated on a wafer by use of a spin coater. The wafer was covered with a mask, exposed to a lamp, and thermally treated at 150° C. for five hours to fabricate a pattern of optical waveguides. FIG. 2 shows this optical waveguide pattern, observed through an optical microscope. FIGS. 3 and 4 show observation results of the optical waveguide pattern in a three- and a two-dimensional atomic force microscopic image, respectively. Without the mask, the coating can be patterned only by use of laser. FIG. 5 is an optical microscopic image of the pattern obtained in this manner.

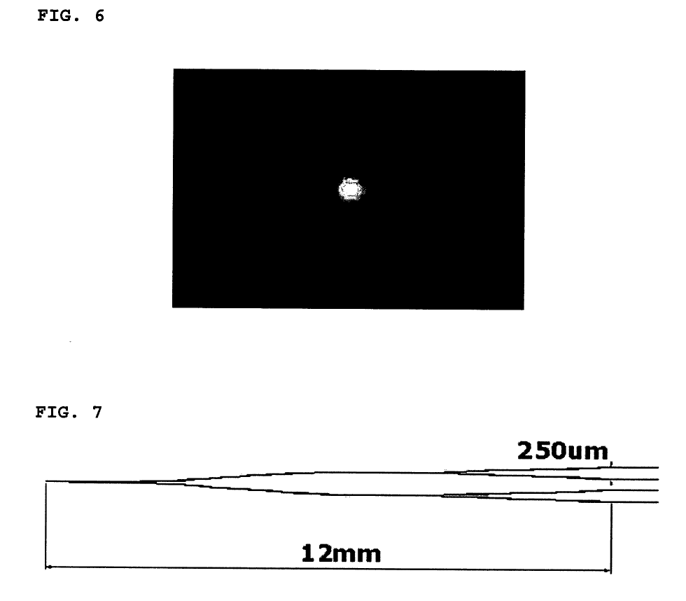

FIGS. 6 to 9 show optical waveguiding characteristics of the pattern of optical waveguides fabricated using the BDK 30 mol % of Example 3.

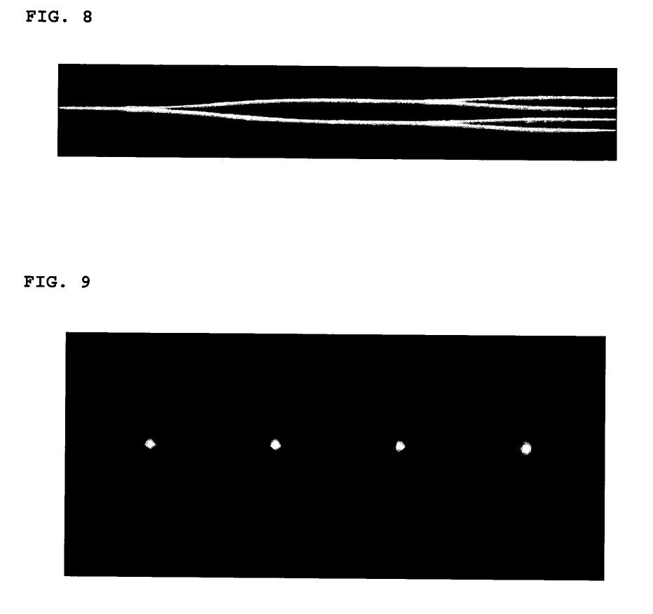

FIG. 6 is a near-field image which shows a single mode is waveguided at 1550 nm in the optical waveguides fabricated. FIGS. 7 and 8 shows a mask pattern and a low magnification microscopic photograph of a 1×4 splitter, respectively. FIG. 9 is a near-field image of a 1×4 splitter fabricated according to the present invention, showing an excellent distribution of light at 1550 nm.

As described hereinbefore, the manufacturing method of the present invention does not require etching processes, thereby reducing a substantial number of processing steps and achieving planar optical waveguides with a low optical loss.

1: A method for manufacturing a planar optical waveguide, comprising the steps of forming a lower cladding layer on a substrate, depositing an optical waveguide layer on the lower cladding layer, patterning the optical waveguide layer, and depositing an upper cladding layer on the patterned waveguide, wherein the optical waveguide layer comprises an inorganic-organic hybrid matrix uniformly doped with photosensitive photochemical monomers, and is selectively exposed to a beam having a predetermined wavelength region, unexposed monomers are removed, and the patterned layer is cured by thermal heating.

2: The method as set forth in claim 1, wherein the hybrid matrix contains silicon and oxygen atoms, with at least a fraction of the silicon being directly bonded to substituted or unsubstituted hydrocarbon groups.

3: The method as set forth in claim 2, wherein the hybrid matrix comprises an oxide of the metal selected from the elements of groups 3A, 4A, 3B-5B of the Periodic Table, and combinations thereof.

4: The method as set forth in claim 2, wherein the hybrid matrix comprises fluorine atoms.

5: The method as set forth in claim 1, wherein the photochemical monomers are selected from the group consisting of monomers capable of being dimerized upon radiation, and combinations thereof.

6: The method as set forth in claim 1, wherein the photochemical monomers are selected from the group consisting of monomers capable of chemically bonding to chains constituting the matrix, in the matrix upon radiation.

7: The method as set forth in claim 1, wherein the photochemical monomers are selected from the group consisting of monomers capable of being polymerized in the matrix upon radiation.

8: The method as set forth in claim 1, wherein the photochemical monomers are selected from the group consisting of ethyl 2-(1-naphthyl)acrylate, coumarin, acenaphthylene, naphthylmethacrylate, naphthylenethiol, benzoinethers, benzylketals, alpha-dialkoxyacetophenones, alpha-hydroxyalkylphenones, alpha-aminoalkylphenones, acyl-phosphine oxides, benzophenone/amines, thioxane/amines, and mixtures thereof.

9: The method as set forth in claim 1, wherein the optical waveguide layer is exposed to a beam through a mask covering the waveguide layer.

10: The method as set forth in claim 1, wherein the optical waveguide layer is exposed to laser without a mask.
